(19) United States
(12) Patent Application Publication
(10) Pub. No.: US 2023/0410323 A1
(43) Pub. Date: Dec. 21, 2023

(54) MOVEMENT PREDICTION WITH INFRARED IMAGING

(71) Applicant: GM Cruise Holdings LLC, San Francisco, CA (US)

(72) Inventor: Siyuan Lu, San Mateo, CA (US)

(73) Assignee: GM Cruise Holdings LLC, San Francisco, CA (US)

(21) Appl. No.: 17/843,714

(22) Filed: Jun. 17, 2022

(51) Int. Cl. G06T 7/215; G06V 20/58; G06V 10/22; B60W 60/00

(52) U.S. Cl. CPC G06T 7/215; G06V 20/58; G06V 10/22; B60W 60/0027; B60W 2420/42; G06T 2207/20084; G06T 2207/10048; G06T 2207/10024; G06T 2207/20212; G06T 2207/30252

(57) ABSTRACT

An environment is captured with a set of sensors to generate a thermal image from an infrared sensor and a visual image from a visual light camera. The thermal image is used to predict movement of objects detected in the environment. The thermal image may be combined with the visual image as a channel of data with the visual image as an input to a prediction model that predicts object movement. Alternatively, the visual image may be used as a guide to identify relevant portions of the thermal image. Objects may be detected and segmented in the visual image and the corresponding portions of the thermal image are segmented and used to predict thermal characteristics for the object. The thermal characteristics may then be used for object movement prediction.

### BACKGROUND

This disclosure relates generally to predicting object movement in an environment and more particularly to predicting object movements with an infrared image.

Sensor systems generally attempt to identify and classify objects in an environment. One particularly challenging problem is to use information about the current state of the environment to predict the future state of the environment, particularly—how will detected objects move over time? Accuracy of these movement predictions for objects may also be particularly difficult for living organisms in the environment. For example, humans, dogs, and other animals may remain still in one moment and move in a direction soon afterwards. Object recognition that primarily uses image data to identify the location and type of objects often struggle with effective prediction of object movement, particularly for detected “objects” in the environment that are alive and may seem to unexpectedly change movement patterns.

### BRIEF DESCRIPTION OF THE DRAWINGS

FIG. 1 shows example components of an autonomous vehicle, according to one embodiment.

FIG. 2 shows components of the control system, according to one embodiment.

FIG. 3 shows one example flow for movement prediction using a visual image and a thermal image, according to one embodiment.

FIG. 4 shows an example in which thermal characteristics are identified and used for movement prediction, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An autonomous vehicle (AV) senses information about its environment with a set of sensors that include an imaging sensor and an infrared (IR) sensor. The imaging sensor captures a visual image of the environment, and the IR sensor likewise captures a thermal image of the environment describing received heat emissions as infrared radiation. To improve movement predictions for detected objects, particularly for living things, the thermal image is included as part of the object detection and/or movement prediction system. While the visual image may capture information about the environment from visible light (e.g., in red, green, and blue color channels) and may be effective for readily detecting different types of objects in an environment, the visual image is supplemented with the thermal image for generating movement predictions of objects.

The thermal image may be used for movement prediction in several ways. In one example, the visual image and the thermal image may be combined for use by a prediction model. The visual image includes one or more color channels (typically, three) for each pixel in the image. To combine the thermal image with the visual image, the coordinates of the thermal image are aligned with the visual image such that the heat information of the thermal image may be added to the image data as an additional thermal “channel” in the representation of the image data. The combined multi-channel input for the different types of sensors may then be input to a prediction model for predicting object movement.

As another example, object segmentation based on the visual image may be used to identify and segment relevant portions of the thermal image. The segmented portions of the thermal image may then be used to generate one or more thermal characteristics of the respective objects in the visual image. The thermal characteristics may be generated based on a trained model or may be based on a set of heuristics. The thermal characteristic(s) for an object may then be used to directly predict object movement for the corresponding object or may be input with the corresponding segmented portion of the visual image to a prediction model that uses the thermal characteristic(s) as a feature for movement prediction of the object.

As such, the thermal image may be used to provide additional information to improve movement prediction for objects in the environment.

Additional details and variations of these aspects are further discussed in detail below.

As will be appreciated by one skilled in the art, aspects of the present disclosure, may be embodied in various manners (e.g., as a method, a system, a computer program product, or a computer-readable storage medium). Accordingly, aspects of the present disclosure may be implemented in hardware, software, or a combination of the two. Thus, processes may be performed with instructions executed on a processor, or various forms of firmware, software, specialized circuitry, and so forth. Such processing functions having these various implementations may generally be referred to herein as a “module.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units and in a different order, unless such an order is otherwise indicated, inherent, or required by the process. Furthermore, aspects of the present disclosure may take the form of one or more computer-readable medium(s), e.g., non-transitory data storage devices or media, having computer-readable program code configured for use by one or more processors or processing elements to perform related processes. Such a computer-readable medium(s) may be included in a computer program product. In various embodiments, such a computer program may, for example, be sent to and received by devices and systems for storage or execution.

This disclosure presents various specific examples. However, various additional configurations will be apparent from the broader principles discussed herein. Accordingly, support for any claims which issue on this application is provided by particular examples, as well as such general principles, as will be understood by one having ordinary skill in the art.

In the following description, reference is made to the drawings where like reference numerals can indicate identical or functionally similar elements. Elements illustrated in the drawings are not necessarily drawn to scale. Moreover, certain embodiments can include more elements than illustrated in a drawing or a subset of the elements illustrated in a drawing. Further, some embodiments can incorporate any suitable combination of features from two or more drawings.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various examples, these are merely examples used to simplify the present disclosure and are not intended to be limiting.

Reference may be made to the spatial relationships between various components and to the spatial orientation of various aspects of components as depicted in the attached drawings. However, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having,” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” generally refers to an inclusive use of “or” (including combinations of listed elements) rather than an exclusive use of “or” (exclusive selection of one element) unless expressly indicated or otherwise inherent to the use of “or.”

### System Overview

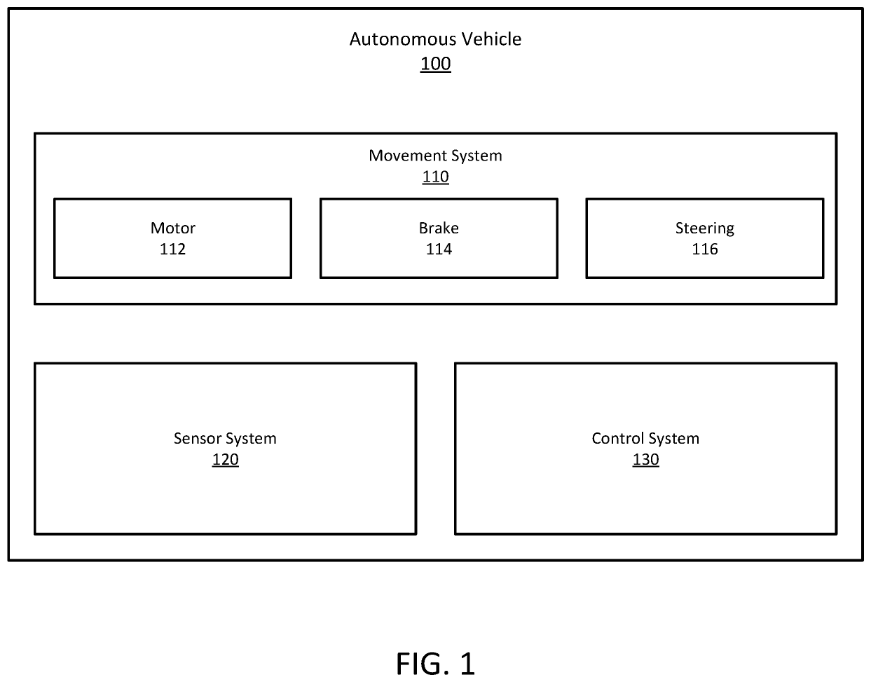

FIG. 1 shows example components of an autonomous vehicle 100, according to one embodiment. In general, an autonomous vehicle 100 includes a movement system 110 to affect physical movement of the autonomous vehicle 100 within an environment surrounding the vehicle, a sensor system 120 that includes a set of sensors for capturing information about the movement of the autonomous vehicle 100 and receiving information about the environment, and a control system 130 that perceives the environment and provides control to the movement system 110 for moving the autonomous vehicle 100 within the environment. In various embodiments, the autonomous vehicle 100 may be completely autonomous and the movement system 110 may be controlled without manual user operation, and in other embodiments may be partially autonomous, such that certain functions or features are automatically provided by the control system 130. In other instances, a user may manually control operation of the movement system 110, for example through various types of manual control mechanisms or inputs, such as pedals, steering wheel, gearbox control, etc. Such manual operation may be provided by an occupant of the autonomous vehicle 100 or may be provided remotely via a communication link to an external operator. In some embodiments, the autonomous vehicle 100 may transition operation to modes with more or less autonomous control based on various conditions, such as a user request, vehicle conditions, or environmental conditions. The autonomous vehicle 100 may also operate with or without an occupant in various embodiments or may activate or deactivate autonomous functions based on occupancy. In some embodiments the autonomous vehicle 100 may include no passenger cabin.

The movement system 110 includes various components for affecting movement of the autonomous vehicle 100 in the environment. As such, the movement system 110 may include a motor 112 that may be connected to a drive system (e.g., wheels) that moves the autonomous vehicle 100. The motor 112 may have multiple operation modes for moving forward, backward, or set to neutral, and may also be set to different speeds/torques (e.g., via various gear ratios). The motor 112 may also be capable of different levels of power output as controlled by a throttle. The movement system 110 may also include a brake 114 for slowing or stopping the movement of the autonomous vehicle 100 along with a steering mechanism 116 for changing the direction of travel of the autonomous vehicle 100. In general, the particular implementation of the components of the movement system 110 enable the autonomous vehicle to start, stop, and change direction in its environment, and may vary according to the particular type of the autonomous vehicle 100. Generally, the movement system 110 thus represents the mechanical components for movement and are controlled by signals received from the control system 130 that designate, for example, an amount of output by the motor, a steering direction for the steering mechanism 116, and so forth.

The sensor system 120 includes a set of sensors for monitoring the autonomous vehicle 100 and the environment around the autonomous vehicle 100. The particular set of sensors and the arrangement thereof may vary according to different examples. As examples, the sensors may include various sensors for monitoring the mechanical performance of the autonomous vehicle 100, such as sensors for monitoring motor performance, fluid levels, air pressure, wheel rotation speed, etc.

The sensors may also include various sensors for localization of the autonomous vehicle 100 within the environment and for perceiving the environment of the autonomous vehicle 100. In general, these sensors may capture various types of modalities of information, such as audio, video, and various electromagnetic frequencies. The sensors may include passive (e.g., receipt-only) and active sensing technologies (e.g., environmental scanning with active transmission and receipt of a return signal). Although certain sensors are discussed here, in practice, more or fewer sensors may be included according to the particular configuration of the various embodiments. The sensors may include one or more imaging sensors, which may include visible-light imaging sensors (e.g., a camera) or an infrared (IR) imaging sensor, radio detection and ranging (RADAR) sensors, or light detection and ranging (LIDAR) sensors. The sensors may also include a receiver for global positioning satellite (GPS) location data, a compass, and receivers for wireless signals, such as cellular or other wireless networks. The sensors may also include receivers for various electromagnetic (EM) signals in various frequencies along with microphones for receipt of audio and other sound information from the environment.

Each sensor may also capture information in respective data formats and modalities according to the capacities of the sensors. For example, an imaging sensor typically captures received light as a two-dimensional image having one or more channels. As such, a visible light camera typically describes color images with color channels in an image space (e.g., as values of red-green-blue, hue-saturation-lightness, hue-saturation-value, cyan-yellow-magenta-key, etc.), while an infrared camera may describe received infrared frequencies in one channel. Similarly, audio capture with a microphone may be described as a frequency waveform, while RADAR/LIDAR data may be represented as a point cloud of data points representing the environment as points at varying distances from the sensor.

The position and placement of the sensors may also vary according to different embodiments and may be calibrated with respect to characteristics of each individual sensor and also with respect to one another to determine the relative position and orientation of each sensor to translate information captured from each sensor to a joint coordinate system. This may permit data from multiple sensors to be aligned to a common coordinate system such that information from multiple sensors may be jointly interpreted.

The sensors may also include various sensors for perceiving the internal condition of the autonomous vehicle 100, such as a microphone to receive any noises or audible instructions from a passenger within the vehicle or a camera for viewing the passenger cabin.

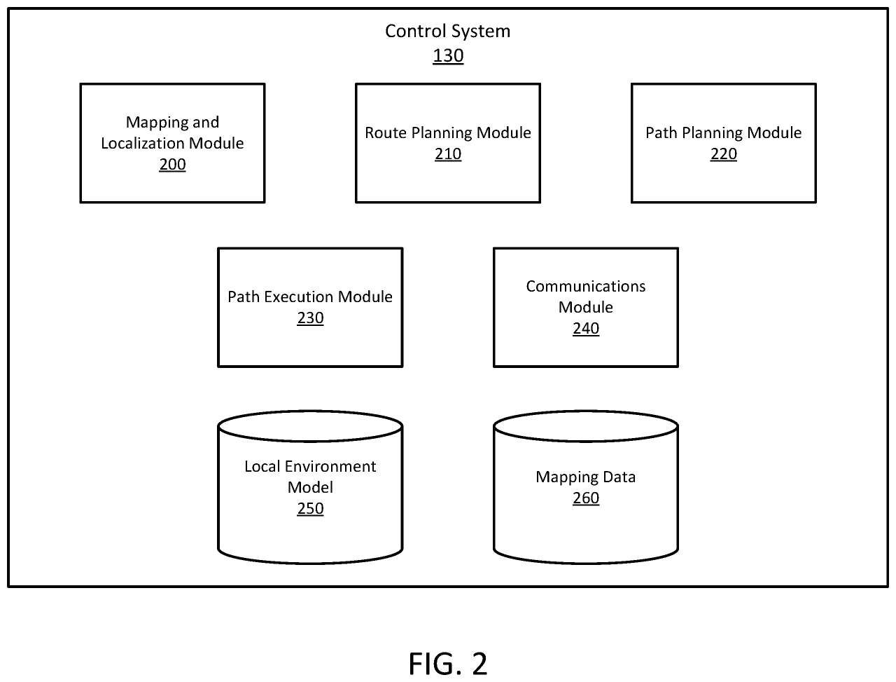

The control system 130 receives sensor data from the sensor system 120 and generates signals for the control of the components of the movement system 110 to navigate the autonomous vehicle 100 within its environment. The control system 130 thus may include components for perceiving the environment based on the sensor data, planning movement, and executing movement with control signals. The control system 130 is further discussed in FIG. 2.

Although generally the autonomous vehicle 100 refers to a vehicle typically operated on a road, such as a car, light truck, heavy truck, principles of this disclosure may also apply to other types of autonomously- or partially-autonomously-operated vehicles. Such additional types of autonomous vehicles 100 may include aerial vehicles such as drones, helicopters, or planes, as well as aquatic vehicles including surface and sub-surface vehicles. As such, the principles discussed herein may generally apply to systems that sense environmental information, analyze and perceive aspects of the environment, and/or provide for automated control of the autonomous vehicle 100.

Not shown in FIG. 1 are various additional components that may be included in various embodiments and are omitted for the purpose of simplifying the discussion herein. For example, the autonomous vehicle 100 may include lights (e.g., headlights, brake lights, etc.), signaling mechanisms, access control (e.g., door locks), battery, fuel storage, and other suitable components.

FIG. 2 shows components of the control system 130, according to one embodiment. The control system 130 includes various components for processing sensor data to perceive the environment of the autonomous vehicle 100 and provide control signals to the movement system 110. The control system 130 may include various computing modules and data storage elements. To perceive and understand the environment, a mapping and localization module 200 may generate and maintain a local environment model 250 that describes conditions of the current environment around the autonomous vehicle 100, such as various objects perceived in the environment based on received sensor data and in conjunction with a set of mapping data 260. Additional modules, such as a route planning module 210, a path planning module 220, and a path execution module 230, determine and execute long- and short-term movement planning. Finally, a communications module 240 may communicate with external systems, both to coordinate movement of the autonomous vehicle 100 and to update software and data components.

In further detail, the mapping and localization module 200 determines and maintains the local environmental model 250 and may implement an environment perception stack for identifying objects and characteristics of the environment. The local environment model 250 may thus describe individual objects in the environment, e.g., objects, people, trees, signs, etc., in a virtual model of the environment consistent with the sensor data. The position of the objects relative to one another along with a current velocity (e.g., with respect to other objects, non-moving/background objects, or the autonomous vehicle 100) may be characterized in the local environmental model 250. The mapping and localization module 200 may also predict future movement of the perceived objects at various timeframes based, e.g., on the current velocity, as well as other sensed data that may predict future change in heading or intention by the object. As such, while the current velocity of a detected object may be expected to continue for at least a short timeframe (e.g., 50 ms), over longer timeframes the objects may be predicted to continue at that heading and speed, slow down, speed up, change direction, and so forth. For example, when a “stop” sign is in the environment ahead of a vehicle, the vehicle may be expected to change its speed to reduce speed and likely stop in the vicinity of the stop sign. The expected movement of objects at different timeframes may thus be predicted with different levels of confidence and may be probabilistically represented according to different types of actions that may be inferred for moving objects. For example, a pedestrian on a street corner may continue to stand at the corner or may, at some future time, enter the street to cross.

To build and update the local environment model 250, the mapping and localization module 200 may process the received data from the various sensors and apply object recognition, motion prediction, and localization algorithms. That is, the mapping and localization module 200 determines objects in the environment, predicts how those objects may move, and determines the location of the autonomous vehicle 100 in relation to the environment. The state of the local environment may thus be stored as the local environment model 250.

To describe the local environment, the sensed information may be processed by various algorithms for perception and object detection. The various sensor data may be individually processed as well as processed in combination with other sensor data of the same or different types. For example, in some embodiments, multiple image sensors may overlap in the portions of the environment viewable by the respective sensors. The captured images may be stitched together to form a larger image for the combined regions, and the respective difference in apparent size and position of an object from the cameras may also be used to infer distance to the object from the images. In some embodiments, imaging sensors may be disposed around the autonomous vehicle, such that the captured images may be merged to form a panoramic view of the environment. In addition, the captured image data and other sensor data (e.g., RADAR and LIDAR point cloud data) may be processed by one or more neural networks for object segmentation and identification. These networks may perform processing on sensor data individually (e.g., initial object identification based on image or LIDAR data alone) and may include networks (or network layers) for joint processing of multiple sensor types together.

The current local environment model 250 may also be sequentially generated and updated at a frequency based on the sensor information since the last update. As such, each local environment model 250 may represent a “frame” of the perceived environment. In addition, the current local environment model 250 may also account for prior captured sensor data (e.g., of a prior frame) and prior frames of the local environmental model in constructing a current local environment model 250. This may permit, for example, object and motion tracking over time to improve object classification as well as movement prediction and to account for objects which may be temporarily obscured by other objects. In some embodiments, the construction and maintenance of the local environment model 250 may be performed based on the captured sensor data by the sensor system 120.

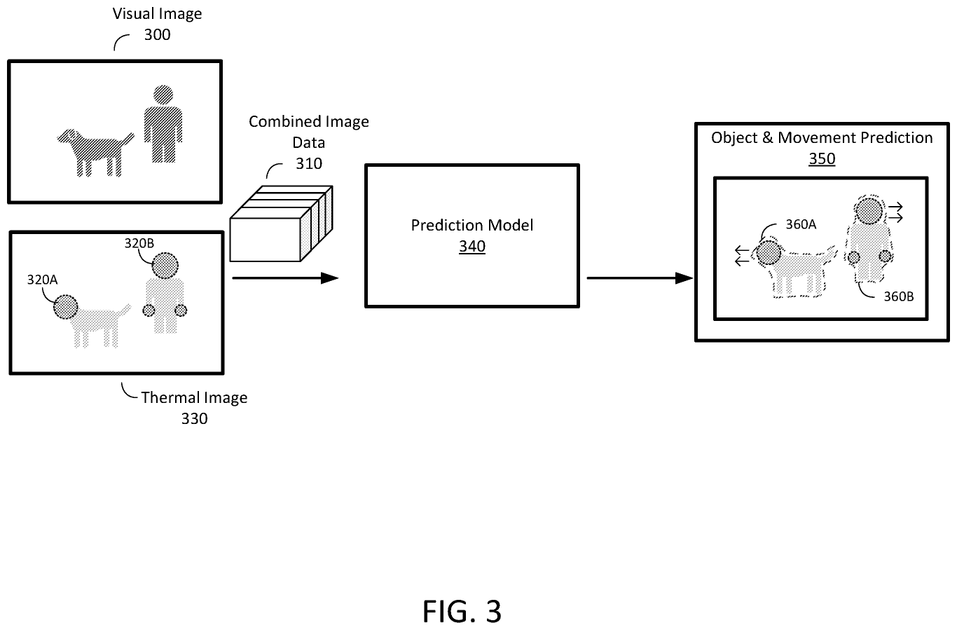

In one embodiment, the sensor data from an IR sensor (i.e., a thermal image) and data from at least the visual camera (a visual image) are used to generate the movement predictions for detected objects. In one embodiment, the movement predictions for an object may be based on a computer model that receives a combined input that includes data channels for the visual image combined with the thermal image. In another embodiment, the movement predictions may be based on thermal characteristics determined from the thermal image and may be in conjunction with objects segmented from the visual image. These approaches for movement prediction are further discussed with respect to FIGS. 3 & 4 below.

The environment mapping may also be performed in conjunction with information from the mapping data 260. The mapping data 260 stores longer-term data about various regions that may be used for localization and route planning. For example, the mapping data 260 may include roads, landmarks, coordinates, road signs and other road control information, and various other information associated with a mapping of the world that is generally expected to be relatively stable over time. Detected objects and other sensor data may be used to determine the position of the autonomous vehicle with respect to the known information in the mapping data 260. For example, the GPS location information may be used to determine the likely position of the vehicle with respect to the mapping data 260. However, as GPS location information may be distorted or imprecise, particularly when navigating environments with many buildings or other interference, additional information may be used to synchronize the perceived environment with the mapping data 260. For example, locally-perceived objects and other signatures of the environment may be matched with known landmarks and characteristics in the mapping data 260. After determining the location of the autonomous vehicle 100 with respect to the mapping data 260, the local environment model 250 may also be supplemented with information from the mapping data 260, for example, to provide information about areas of the environment beyond the perception range of the sensors of the sensor system 120. This information may be useful, for example, for longer-term motion planning or movement prediction of other objects. For example, the sensors may perceive objects that obscure road signs from the sensor system 120 that may be known or expected in the environment based on the mapping data 260.

The local environment model 250 may also be used to update the mapping data 260 when the locally-sensed data differs from the mapping data 260. For example, the sensor data may not perceive a road sign at a location designated in the mapping data 260 despite a view of that location, or a road may be closed or under construction or otherwise in a different condition than designated in the mapping data 260. The mapping and localization module 200 may communicate differences between the mapping data 260 and the locally-perceived environment to an external system that maintains the mapping data 260.

The route planning module 210 determines longer-range planning and routing for the autonomous vehicle 100 and may determine, for example, an expected navigation route from an origin to a destination. Conceptually, the route planning module 210 may determine the high-level navigation objective and route, in contrast to the path planning module 220, which may determine short-term navigation with respect to the local environment model 250. While discussed here as separate components, in practice, these components may be jointly implemented, and the longer-term route planning may be affected by information discovered from the local path execution or environmental perception. For example, a planned route may indicate travel along a road that the local environment model 250 indicates is not available or for which there is no executable path to reach, such that another destination or route must be determined.

The route planning module 210 may determine the current location of the autonomous vehicle 100 and a destination and the overall route (e.g., individual roads and turns) to arrive at the destination from the current location. The route may be determined by available ways to reach the destination from the origin and evaluated with respect to traversal costs such as expected travel speeds, fuel usage, time, ride smoothness/passenger comfort, traffic, and so forth. The available ways of reaching the destination may be explored by various traversal algorithms based on the costs of traversing different routes and cost preferences for combining different types of costs.

The route planning module 210 may also receive instructions from an external system specifying a route or a destination. For example, the external system may coordinate destinations for many autonomous vehicles, such as destinations for passenger or cargo pickup/delivery, for vehicle maintenance or refueling, and so forth. The destination and/or a route for reaching the destination may thus be determined by the route planning module 210 or provided by the external system.

The path planning module 220 determines a path for navigating the local environment based on the local environment model 250 and the desired route specified by the route planning module 210. As such, the route from the route planning module 210 may provide a route indicating that the autonomous vehicle should turn right at the next street in approximately two miles. The path planning module 220 evaluates objects in the local environment (e.g., other cars, pedestrians, etc.) and determines the desired path for the autonomous vehicle 100 to navigate to and execute the turn. This may include, for example, changing lanes to a turn lane based on available space in the turn lane, stopping at the intersection, executing the turn, and so forth.

The path planning module 220 may look ahead an amount of time in predicting the movement of objects during its planning and update the planned path for each frame that the local environment model 250 is updated. The path planning module 220 may thus provide desired speed, turning, and other information to the path execution module 230 for execution.

The path execution module 230 executes the path with the various movement control signals for the movement system 110 to execute. Such signals may control application of the throttle, brake, and steering to execute the planned path. The path execution module 230 may include feedback mechanisms for verifying expected execution of the signals by the movement system 110, for example, to confirm a wheel-speed sensor is affected by application of the brake or throttle or that the specified speed along the path is achieved by the applied throttle signal. As such, the path execution module 230 translates the higher-level path instructions to specific signals that control the physical components of the movement system 110.

The communications module 240 coordinates messaging with other systems and devices. As one example, the communications module 240 may be used for updating the mapping data 260 based on data kept by an external data source. As another example, the communications module 240 may provide diagnostic, operations, and safety information for monitoring of the autonomous vehicle 100. As such, the communication module 240 may use respective communication components (e.g., transceivers) for various communication modalities such as cellular or wireless communications.

The control system 130 may include additional modules or components for control and management of the autonomous vehicle 100 that are not explicitly shown here. For example, the control system 130 may include voice recognition and control components for interpreting commands by a passenger, a module for coordinating communication of the passenger with a remote technician via the communications module 240, and modules for operating various other features or components of the autonomous vehicle 100.

### Thermal Imaging for Movement Prediction

FIG. 3 shows one example flow for movement prediction using a visual image 300 and a thermal image 330, according to one embodiment. The movement prediction may be performed by the mapping and localization module 200 for identifying objects in the local environment model 250 and the predicted movements thereof. The visual image 300 may be captured from a visual light camera, and the thermal image 330 may likewise be captured from an IR camera. In general, the sensors capturing the environment may capture overlapping portions of the environment as shown in the respective visual image 300 and thermal image 330 in FIG. 3. Each of these sensors may capture different types of data—the visual image 300 typically describes the data captured in the image as multiple color channels, reflecting visual light waves received in each of the respective color wavelengths (e.g., RGB). The thermal image 330 likewise captures sensor data for the environment reflecting IR waves that may describe the thermal temperature of portions of the environment. As shown in the thermal image 330, different objects in the environment may have different thermal output, and different portions of an object may emit heat in different ways or at different temperatures. In the example of FIG. 3, the thermal image may show increased heat output 320A near a dog's face and increased heat output 320B near a person's face and hands. As such, the thermal image 330 may provide distinctive heat information about objects, particularly living objects in which the heat may be emitted particularly by skin, faces, hands, etc.

However, while portions of an object may be relatively easy to detect in the thermal image 330 (e.g., the higher heat areas of the dog and the person), it may be difficult to determine the complete outline of objects in the thermal image, distinguish objects, and so forth. In one embodiment, the visual image 300 and the thermal image 330 are combined to form combined image data 310 for input to a prediction model 340. The combined image data 310 includes the color channels of the visual image 300 and adds the thermal image 330 as an additional channel of data in the combined image. Hence, if the visual image has a height, width, and channels C (typically 3), forming data to be input to the prediction model of dimensions H×W×C, the thermal image 330 may be added to increase the channels C to include the thermal image. Because the thermal image 330 and the visual image 300 are typically captured by different sensors and may have different resolutions, the thermal and/or visual image may be transformed to align the data between the two sources to a common perspective on the environment. As such, the image data (from either sensor) may be resized, cropped, translated, and otherwise manipulated such that the combined image data at a particular pixel in the image data represents the same location in the environment as perceived by each of the respective sensors. The respective manipulations may be determined based on the respective resolutions of the sensors as well as a calibration of the sensors with respect to one another when the sensors are affixed to the autonomous vehicle. The calibration may provide parameters (e.g., translation and rotation values) to describe the translation of the captured sensor data to a common coordinate system.

The prediction model 340 receives the combined image data 310, segments and classifies objects in the combined image, and predicts movement of the detected objects within the environment. This output is shown as object & movement prediction 350.

The prediction model 340 may be a neural network or other type of computer-trained model that learns to segment objects in the environment, classify the objects into types, and predict movement of the objects. In one embodiment, the model may sequentially perform these operations (e.g., segment the combined image data 310 into regions of interest that may include an object, then classify the regions, then predict movement), and in other embodiments one or more of these characteristics may be simultaneously determined (e.g., the regions of interest in combination with the classification may be performed at the same time). The prediction model 340 may be a deep neural network including various types of layers, such as convolutional layers, rectification layers, activation layers, pooling, predictive layers, fully-connected layers, and so forth; additional types of layers and models for forming object/movement predictions 350 may also be used. In addition, while shown as processing the combined image data 310, the prediction model 340 may also include layers that include sensor data from additional sensors, such as LIDAR or RADAR, which may be jointly processed by one or more layers of the prediction model 340. In other embodiments, objects may be recognized by other sensor types separately and combined as recognized objects in different modalities.

The object segmentation and classification refers to identifying objects; and for each object, segmentation refers to identifying a location of the object within the sensor data (e.g., coordinates, a bounding box, or other region of the object), while classification refers to identifying a type of the object. The location may be described in different ways for different sensor data, and the combined image data may describe one or more rectangular regions in the image corresponding to the object, although a more complex boundary designating the object or the designation of individual pixels or groups of pixels as belonging to the object may also be used to define the region of the object. The objects may be classified at different levels and may represent different classes or subclasses of object. For example, an object may be identified as “living” and then a subclass of “four-legged” and then “dog.” As such, the segmented and classified objects indicate a particular type of object at a particular region of the image data. The segmentation is shown in FIG. 3 for the detected objects 360A, B as dotted lines indicating the respective region/portion of the image detected for the object. Likewise, object 360A may be classified as a “dog” and object 360B may be classified as a “person.”

The movement prediction may predict the likely movement or trajectory of the detected objects over time. The movement prediction may be calculated for different timeframes and may include a predicted immediate velocity (e.g., movement with respect to the immediate next sensor/perception frame, which may be measured in tenths or hundredths of a second) and may include longer-term intent that accounts for change of speed and/or direction of the detected object over several seconds or a minute. While the immediate velocity may be strongly affected by the preceding velocity (e.g., the rate of change of position of the object from the last detected image frame to the current image frame), movement prediction at longer timeframes may be more effectively predicted by prediction model 340. The prediction model 340 may also receive, as an input, previously-detected objects and respective movements thereof. As such, the predicted movement from the prediction model may be output to describe the predicted movement of an object at different future timeframes (e.g., the next frame, in half a second, in one second, in five seconds, in ten seconds, etc.). In addition, the predicted movement may be of a specific direction (left by one meter or away from the camera by two meters) or may be a probability distribution/density of multiple potential movements at the particular timeframe. Different timeframes may also represent movement predictions differently; for predicting the next half second, the prediction may be a direction and distance, while the prediction for the next ten seconds may be described as a probabilistic distribution/density as the likely object movement may diverge more significantly in ways that affect path planning based on the predicted movement.

To perform the object and movement prediction, the prediction model 340 may have parameters, such as weights or other values for individual layers as well as hyperparameters for the structure of the model as a whole, that are trained during a model training process. The model may be trained based on a set of training data to learn values for the parameters that optimize an optimization function (or, alternatively stated, minimize a loss function). The model may be trained by a system external to the system (e.g., the AV 100) implementing the prediction model 340 and the model may be updated for implementation by the mapping and localization module 200 via the communications module 240. To train the model with respect to object recognition/segmentation, the training data may include a set of labeled training data indicating object type and corresponding portions of the image to be segmented to that object type.

Similarly, to train the model with respect to movement prediction, the training data may include labeled training data labeled with respect to the actual movement of the objects for the timeframes to be predicted by the model. In one embodiment, the training data may be labeled automatically based on captured sensor data and monitored movement of objects over time by sensors. For example, the environment may be monitored over a period of time in which visual images, thermal images, and other related sensor data is collected. Objects may be identified by an object detection algorithm that may then be tracked over sequential frames to determine the movement of the detected object over time. As such, a visual image 300 and a thermal image 330 captured in the environment at an initial time may be labeled with a tracked movement that occurs at a future time (e.g., in the next frame, in a frame captured half a second after the initial time, in a frame captured a second after the initial time, etc.). In other embodiments, the movement of objects may be labeled manually or by other means. As such, the input combined image data 310 and the output movement at different times may be labeled and learned by the parameters of the prediction model 340.

In one embodiment, the object segmentation and classification may be performed by another perception process or model (e.g., using other types of sensors or based on the visual image 300 without the thermal image 330) and the prediction model 340 as shown in FIG. 3 receives the recognized objects and combined image data 310 to predict the movement of the recognized objects.

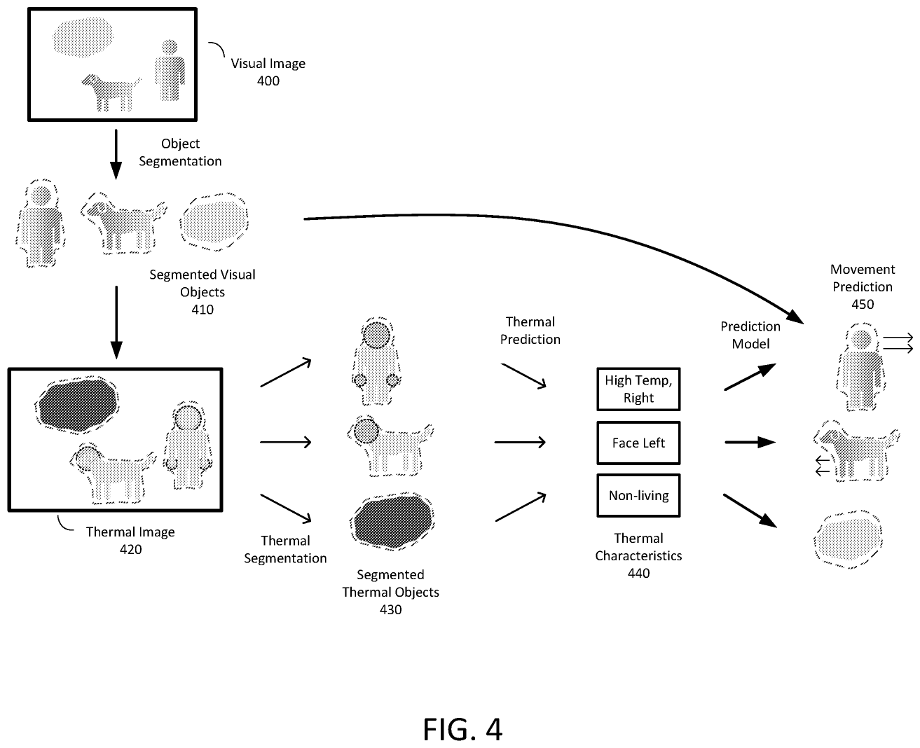

FIG. 4 shows an example in which thermal characteristics are identified and used for movement prediction 450, according to one embodiment. In this example, rather than combining the thermal image 420 with the visual image 400 as an input to a model that generates movement predictions 450 directly, the thermal image 420 may be used to determine thermal characteristics of an object. The thermal characteristics may be input to the movement prediction model for that object. In this example, the visual image 400 is processed by an object identification and segmentation model (e.g., as discussed above) to identify segmented visual objects 410 identified in the visual image 400. The segmented visual objects 410 may be classified as having a type of object and having associated regions of the visual image 400. In this case, the segmented visual objects 410 may be identified as a person, a dog, and an “unknown” object.

With the segmented visual objects 410 from the visual image 400, the corresponding regions of the thermal image 420 may be segmented to identify the corresponding regions of the thermal image 420 that form segmented thermal objects 430 that correspond to the segmented visual objects 410. As noted above with respect to combining visual and thermal images, coordinates in the visual image 400 for the segmented visual objects 410 may be converted to respective coordinates in the thermal image 420, e.g., with respect to the differing positions of the sensors, different resolutions of the images, etc.

In one example, the segmented thermal objects 430 may also be processed by a thermal prediction algorithm to determine one or more thermal characteristics 440 of the objects. The thermal characteristics may be used to describe an aspect of an object as determined from the thermal image 420. The thermal characteristics may be used to describe heading, attention (e.g., where a person is attending), and other information that may be used to determine movement prediction 450. In this example, the person is determined to have a thermal characteristic of turning the face to the right and of having a particularly high temperature (e.g., relative to a normally-perceived human temperature), while the dog is determined to have its face to the left based on the heat signature of the segmented thermal object 430 for the dog. In addition, in this example the visual object having an “unknown” type may be assessed for additional characteristics, such as to determine whether the object is living or non-living. The thermal characteristics 440 may be used directly for movement prediction (e.g., the left-facing dog may be directly predicted to move in the direction it is facing) or the thermal characteristics 440 may be an input for further processing by a movement prediction model to generate movement prediction 450. In this example, a prediction model may be applied to the segmented visual objects 410 to determine the movement prediction 450 for the detected objects. In this example, the thermal characteristics 440 may be an additional feature input to the prediction model that may include additional sensor data and may have a structure similar to the model discussed in FIG. 3 (except that the input may include the segmented visual objects 410 and thermal characteristics 440 rather than the combined image data).

The thermal characteristics 440 may be determined based on rules and/or heuristics to select one or more thermal characteristics for the object. In addition to the use of the thermal characteristics 440 in the movement prediction 450, particular thermal characteristics 440 may also be associated with particular movements without requiring additional processing by further models. The rules/heuristics to be applied may be specific to certain types of objects, for example objects of type “unknown” may be evaluated by a “living/nonliving” rule that evaluates whether the thermal characteristics of the object are different than the overall environment, and if so whether different portions of the object vary in their thermal values or exceed a minimum temperature required for a living object. When the object is considered living, it may be considered to have a higher likelihood for changing movement trajectory (e.g., without apparent contact with other features of the environment) than non-living objects.

As additional examples, a “high temperature” for a person may be determined by comparing the highest temperature (or the temperature localized to an identifiable face) to a threshold. The high temperature may indicate, for example, a person with a fever, who may be less likely to move quickly, or an agitated person who may be more likely to move erratically. As an additional example, the thermal characteristics 440 may describe the relative position and orientation of the face relative to the detected object. For example, when the face of an object classified as a person is not viewable in the segmented thermal object 430 (e.g., when no higher-temperature area is detected), it may determine how the detected object is likely oriented and will move away from the sensor. In the example of FIG. 4, the segmented thermal object 430 classified as a dog is identified as facing left based on the area of higher temperature on the left side of the segmented object and may be used to predict an increased likelihood that the dog moves “left” with respect to the perspective of the thermal sensor.

In addition to rules/heuristics, the thermal characteristics 440 may be determined by other means, for example by a computer model that learns a relationship of a segmented thermal object 430 and individual thermal characteristics 440 for different types of objects. The model for predicting thermal characteristics may receive as an input the segmented thermal object 430 and the associated type of the object. Alternatively, a set of models may be individually trained for different object types and a model may be selected for a particular segmented thermal object based on the object type. The model may then be trained based on the segmented thermal object 430 to output the likelihood of one or more thermal characteristics 440.

By using object recognition of the visual image 400, the corresponding portion of the thermal image 420 may thus be extracted and used to provide thermal characteristics 440 for the objects identified in the visual image 400. As thermal images may often be difficult to accurately segment for object detection while simultaneously including information that may be particularly useful for determining future movement (e.g., heading and intention) of living objects, the combination of visual and thermal information (by the various approaches discussed herein) provide for more accurate predictions of object movement and effective determination of thermal characteristics.

### EXAMPLE EMBODIMENTS

Various embodiments of claimable subject matter includes the following examples.

Example 1 provides a method for receiving sensor data for an environment of an autonomous vehicle including a visual image of the environment and a thermal image of the environment; identifying a set of objects in the environment based on the sensor data; and determining a movement prediction of an object in the set of objects based at least in part on a portion of the thermal image including the object.

Example 2 provides for the method of example 1, wherein the set of objects is identified based on a prediction model that receives the visual image and the thermal image of the environment.

Example 3 provides for the method of example 2, wherein the visual image has one or more color channels and the thermal image is combined with the visual image as an additional color channel for input to the prediction model

Example 4 provides for the method of any of examples 1-3, further including determining a region of the object in the visual image; and determining the movement prediction of the object based in part on the corresponding region in the thermal image.

Example 5 provides for the method of example 4, further including determining a characteristic of the object based on the corresponding region in the thermal image.

Example 6 provides for the method of example 5, wherein determining the movement prediction of the object includes providing the region of the object in the visual image and the characteristic to a prediction model.

Example 7 provides a system including receiving sensor data for an environment of an autonomous vehicle including a visual image of the environment and a thermal image of the environment; identifying a set of objects in the environment based on the sensor data; and determining a movement prediction of an object in the set of objects based at least in part on a portion of the thermal image including the object.

Example 8 provides for the system of example 7, wherein the set of objects is identified based on a prediction model that receives the visual image and the thermal image of the environment.

Example 9 provides for the system of example 8, wherein the visual image has one or more color channels and the thermal image is combined with the visual image as an additional color channel for input to the prediction model.

Example 10 provides for the system of any of examples 7-9, wherein the instructions are further executable by the processor for

Example 11 provides for the system of example 10 determining a region of the object in the visual image; and determining the movement prediction of the object based in part on the corresponding region in the thermal image.

Example 12 provides for the system of example 11, wherein determining the movement prediction of the object includes providing the region of the object in the visual image and the characteristic to a prediction model.

Example 13 provides a non-transitory computer-readable medium containing instructions executable by a processor for receiving sensor data for an environment of an autonomous vehicle including a visual image of the environment and a thermal image of the environment; identifying a set of objects in the environment based on the sensor data; and determining a movement prediction of an object in the set of objects based at least in part on a portion of the thermal image including the object.

Example 14 provides for the computer-readable medium of example 13, wherein the set of objects is identified based on a prediction model that receives the visual image and the thermal image of the environment.

Example 15 provides for the computer-readable medium of example 14, wherein the visual image has one or more color channels and the thermal image is combined with the visual image as an additional color channel for input to the prediction model.

Example 16 provides for the computer-readable medium of any of examples 13-15, wherein the instructions are further executable for determining a region of the object in the visual image; and determining the movement prediction of the object based in part on the corresponding region in the thermal image.

Example 17 provides for the computer-readable medium of example 16, wherein the instructions are further executable for determining a characteristic of the object based on the corresponding region in the thermal image.

Example 18 provides for the computer-readable medium of example 17, wherein determining the movement prediction of the object includes providing the region of the object in the visual image and the characteristic to a prediction model.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Specifications, dimensions, and relationships outlined herein (e.g., the number of processors, logic operations, etc.) have been offered for purposes of example and teaching only. Such information may be varied considerably without departing from the spirit of the present disclosure or the scope of the appended claims. In the foregoing description, various non-limiting example embodiments have been described with reference to particular arrangements of components. Various modifications and changes may be made to such embodiments without departing from the scope of the appended claims. This description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this disclosure.

Note that in this specification, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like, are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving sensor data for an environment of an autonomous vehicle including a visual image of the environment and a thermal image of the environment;
identifying a set of objects in the environment based on the sensor data; and
determining a movement prediction of an object in the set of objects based at least in part on a portion of the thermal image including the object.

2. The method of claim 1, wherein the set of objects is identified based on a prediction model that receives the visual image and the thermal image of the environment.

3. The method of claim 2, wherein the visual image has one or more color channels and the thermal image is combined with the visual image as an additional color channel for input to the prediction model.

4. The method of claim 1, further comprising:
determining a region of the object in the visual image; and
determining the movement prediction of the object based in part on the corresponding region in the thermal image.

5. The method of claim 4, further comprising determining a characteristic of the object based on the corresponding region in the thermal image.

6. The method of claim 5, wherein determining the movement prediction of the object includes providing the region of the object in the visual image and the characteristic to a prediction model.

7. A system comprising:
receiving sensor data for an environment of an autonomous vehicle including a visual image of the environment and a thermal image of the environment;
identifying a set of objects in the environment based on the sensor data; and
determining a movement prediction of an object in the set of objects based at least in part on a portion of the thermal image including the object.

8. The system of claim 7, wherein the set of objects is identified based on a prediction model that receives the visual image and the thermal image of the environment.

9. The system of claim 8, wherein the visual image has one or more color channels and the thermal image is combined with the visual image as an additional color channel for input to the prediction model.

10. The system of claim 7, wherein the instructions are further executable by the processor for:
determining a region of the object in the visual image; and
determining the movement prediction of the object based in part on the corresponding region in the thermal image.

11. The system of claim 10, wherein the instructions are further executable by the processor for determining a characteristic of the object based on the corresponding region in the thermal image.

12. The system of claim 11, wherein determining the movement prediction of the object includes providing the region of the object in the visual image and the characteristic to a prediction model.

13. A non-transitory computer-readable medium containing instructions executable by one or more processors for:
receiving sensor data for an environment of an autonomous vehicle including a visual image of the environment and a thermal image of the environment;
identifying a set of objects in the environment based on the sensor data; and
determining a movement prediction of an object in the set of objects based at least in part on a portion of the thermal image including the object.

14. The computer-readable medium of claim 13, wherein the set of objects is identified based on a prediction model that receives the visual image and the thermal image of the environment.

15. The computer-readable medium of claim 14, wherein the visual image has one or more color channels and the thermal image is combined with the visual image as an additional color channel for input to the prediction model.

16. The computer-readable medium of claim 13, wherein the instructions are further executable for:
determining a region of the object in the visual image; and
determining the movement prediction of the object based in part on the corresponding region in the thermal image.

17. The computer-readable medium of claim 16, wherein the instructions are further executable for determining a characteristic of the object based on the corresponding region in the thermal image.

18. The computer-readable medium of claim 17, wherein determining the movement prediction of the object includes providing the region of the object in the visual image and the characteristic to a prediction model.
